(19) United States
(12) Patent Application Publication
(10) Pub. No.: US 2016/0012430 A1
(43) Pub. Date: Jan. 14, 2016

(54) HANDS-FREE OFFLINE COMMUNICATIONS

(71) Applicant: GOOGLE INC., Mountain View, CA (US)

(72) Inventors: Sashikanth Chandrasekaran, Belmont, CA (US); Thai Ngoc Duong, Sunnyvale, CA (US); Denise Ho, Los Altos, CA (US); William Hartley Setchell, East Palo Alto, CA (US); Diana K. Smetters, Belmont, CA (US); Sheldon I. Walfish, Palo Alto, CA (US); Zhihong Xu, Sunnyvale, CA (US)

(21) Appl. No.: 14/797,029

(22) Filed: Jul. 10, 2015

Related U.S. Application Data
(60) Provisional application No. 62/023,759, filed on Jul. 11, 2014.

(51) Int. Cl. G06Q 20/38; G06Q 20/40

(52) U.S. Cl. CPC G06Q 20/385; G06Q 20/405

(57) ABSTRACT

A payment processing system receives a token from a user device. Based on the first token, the payment processing system establishes a second token that remains valid longer than the first token. The payment processing system then associates the second token with a user account identifier and establishes a rescue code for use in an offline user transactions. The payment processing system then communicates the second token and the rescue code to the user device. When the user engages in an offline transaction, the payment processing system receives the rescue code and the user account identifier from the merchant computing device. Based on the user account identifier received from the merchant computing devices, the payment processing system identifies the second token and verifies that the received rescue code matches the rescue code associated with the user account identifier. Based on the verification, the payment processing system authorizes the sales transaction.

### CROSS-REFERENCE TO RELATED APPLICATIONS

This patent application claims priority to U.S. Provisional Patent Application No. 62/023,759, filed Jul. 11, 2014, and entitled “Hands-free Offline Transactions.” The entire disclosure of the above-identified priority application is hereby fully incorporated herein by reference.

### TECHNICAL FIELD

The present disclosure relates to verifying that rescue codes in offline hands-free transactions received from merchant computing systems match the rescue codes associated with user account identifiers to allow payment processing systems to authorize sales transactions.

### BACKGROUND

When consumers make purchases at a merchant location, many methods of conducting a transaction are available. Consumers may use many different cards or accounts for purchases, such as gift cards, debit cards, credit cards, stored value cards, and other cards or accounts. The user account identifiers and other data represented by the cards may be communicated to the merchant system via magnetic stripes, near field communication technologies, and other suitable mechanisms.

Current applications for conducting transactions at a merchant location do not provide the opportunity for the consumer to make a hands-free transaction. Current applications require the consumer to perform actions to provide the user account identifiers and other data to the merchant system. Current applications, such as for conducting hands-free transactions, also require the user device of a user to be connected to a communication network.

### SUMMARY

In certain example aspects described herein, computer-implemented methods to complete offline transactions are provided. For example, a user computing device that is associated with a financial account of a user creates a first token. A payment processing system then receives the first token from the user computing device. In response to receiving the first token, the payment processing system establishes a second token that remains valid longer than the first token. The payment processing system then associates the second token with a user account identifier for the user and establishes a rescue code for use in an offline sales transaction of the user. In another example, the rescue code is based on a shared secret that is initially exchanged between the payment processing system and the user computing device. After associating the user account identifier with the rescue code, the payment processing system communicates the rescue code and the user account identifier to the user computing device of the user.

When the user engages in a sales transaction with a merchant, for example, the merchant computing device receives the rescue code and the user account identifier from the user computing device. Then, the payment processing system receives the rescue code and the user account identifier from the merchant computing device. Based on the user account identifier received from the merchant computing devices, the payment processing system identifies the second token associated with the user account identifier. The payment processing system then verifies that the rescue code received from the merchant computing system matches the rescue code associated with the user account identifier. In response to verifying that the rescue code received from the merchant computing system matches the rescue code associated with the user account identifier, the payment processing system authorizes, by using the second token, a sales transaction involving the user financial account.

In certain other example aspects, systems and computer program products to complete offline transactions are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system for conducting hands-free transactions, in accordance with certain example embodiments.

FIG. 2 is a block flow diagram depicting a method for conducting hands-free transactions, in accordance with certain example embodiments.

FIG. 3 is a block flow diagram depicting a method for a merchant device to broadcast the beacon via a wireless communication, in accordance with certain example embodiments.

FIG. 4 is a block flow diagram depicting a method for a user computing device to recognize the merchant computing device beacon, in accordance with certain example embodiments.

FIG. 5 is a block flow diagram depicting a method for processing a payment via a user identifier and rescue code when the user computing device is offline, in accordance with certain example embodiments.

FIG. 6 is a block diagram depicting a computing machine and module, in accordance with certain example embodiments.

### DETAILED DESCRIPTION OF EXAMPLE EMBODIMENTS

### Overview

The example embodiments described herein provide computer-implemented techniques for conducting hands-free transactions or other exchange between a user computing device and a merchant computing device. In an example embodiment, a user installs a hands-free application on a user computing device. The user maintains a user account on a payment processing system for conducting transactions. A merchant computing device at a merchant location provides a beacon identifier that is received by the user computing device.

The user computing device generates a token for conducting a transaction and transmits the token to the payment processing system. Upon verification, the payment processing system transmits the token to the merchant computing device. The merchant computing device stores the token for use in a transaction with the user computing device.

The user approaches the salesperson to conduct a transaction using the hands-free application. The salesperson initiates the transaction on the merchant computing device and identifies the user on a user interface of the merchant computing device. The merchant computing device transmits the transaction details and the token for the user to the payment processing system. The payment processing system verifies the details of the transaction and the token, and conducts the transaction. The payment processing system communicates a notification to the user computing device with the transaction data.

In certain examples, the user and the user computing device may be in a location where the user computing device cannot connect to a communication network to communicate with the payment processing system and hence is offline. Thus, the hands-free method described herein may not be available. As such, an alternative method is needed to complete the sales transaction when the user computing device is offline.

For example, after creating a token, the user computing device may periodically transmit the token to the payment processing system when the user computing device is connected to the network. The payment processing system then converts the token to one or more longer-lasting, durable tokens, which the payment processing system associates with the user's account. The payment processing system also creates one or more rescue codes and a user-specific account identifier that the payment processing system associates with the user account. The payment processing system then transmits the rescue code(s) and the user account identifier to the user computing device. In another embodiment, the payment processing system and the user computing device exchange a shared secret for comparison instead of a rescue code.

When the user is unable to connect the user computing device to the network or is otherwise unable to communicate with the payment processing system (and is hence offline), the user computing device provides a rescue code and the user account identifier to the salesperson at a merchant location. The salesperson then inputs the rescue code, the user account identifier, and transaction details into the merchant system for transmission to the payment processing system. When the payment processing system receives the information, the payment processing system uses the user account identifier to locate the durable token for the user. The payment processing system also verifies that the received rescue code matches the rescue code associated with the account identifier. Based on locating the durable token with the user account and the verification of the rescue code, the payment processing system authorizes and processes the transaction.

By using and relying on the methods and systems described herein, the payment processing system dynamically authorizes sales transactions for offline transactions. As such, the systems and methods described herein may be employed to allow rescue codes to be provided to the payment processing system by a merchant system to authenticate a user. Hence, the methods and systems described herein permit transactions when a user is in a location where the user computing device cannot communicate with the payment processing system and hence must be offline. The hands-free methods described herein allow the user computing device to complete the sales transaction when the user computing device is offline.

### Example System Architecture

Turning now to the drawings, in which like numerals indicate like (but not necessarily identical) elements throughout the figures, example embodiments are described in detail.

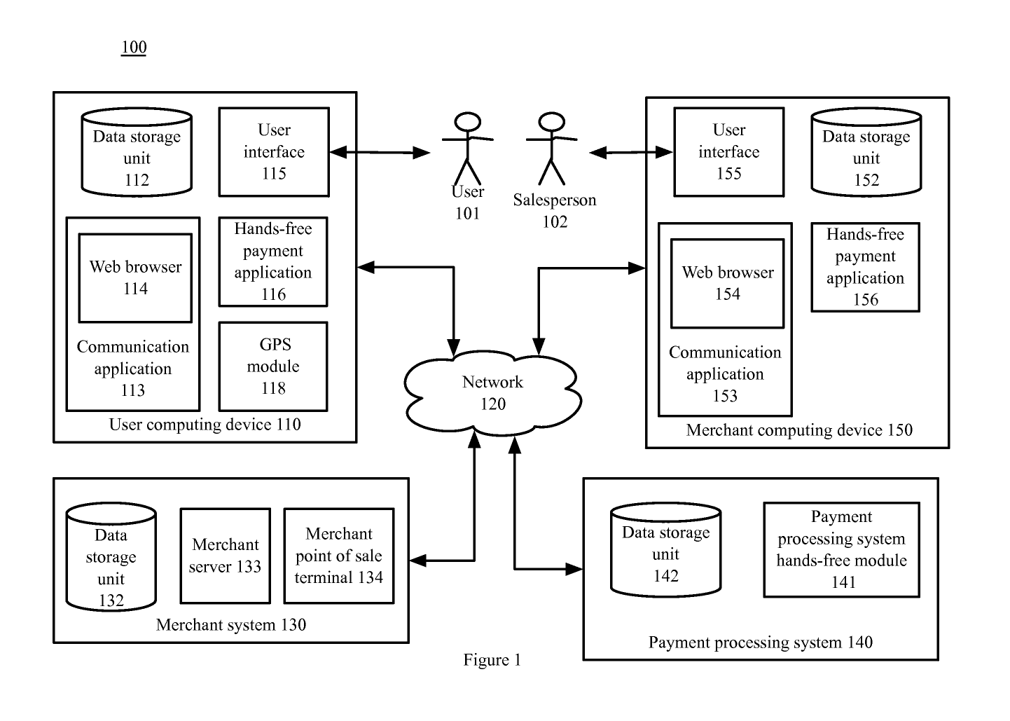

FIG. 1 is a block diagram depicting a system 100 for conducting hands-free transactions, in accordance with certain example embodiments. As depicted in FIG. 1, the system 100 includes network computing devices 110, 130, 140, and 150 that are configured to communicate with one another via one or more networks 120. In some embodiments, a user 101 or a salesperson 102 associated with a device must install an application and/or make a feature selection to obtain the benefits of the techniques described herein.

In example embodiments, the network 120 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy, near field communication (“NFC”), Wi-Fi, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing device 110, 130, 140, and 150 includes a device having a communication module capable of transmitting and receiving data over the network 120. For example, each network computing device 110, 130, 140, and 150 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 130, 140, and 150 are operated by users 101, merchant system operators, salespersons 102, and payment processing system operators, respectively.

In the examples provided herein, actions performed by the first user 101 may be performed by the salesperson 102 in other embodiments. Examples described as being performed by the user computing device 110 may be performed by the merchant computing device 150 in other embodiments.

An example user computing device 110 comprises a data storage unit 112, a communication application 113, a web browser 114, a user interface 115, a global positioning system (“GPS”) module, and a hands-free payment application 116.

In an example embodiment, the data storage unit 112 comprises a local or remote data storage structure accessible to the user computing device 110 suitable for storing information. In an example embodiment, the data storage unit 112 stores encrypted information, such as HTML5 local storage.

In an example embodiment, the first user 101 uses a communication application 113, such as a web browser 114 application or a stand-alone hands-free payment application 116, to view, download, upload, or otherwise access documents or web pages via a distributed network 120.

In an example embodiment, the communication application 113 can interact with web servers or other computing devices connected to the network 120, including the user computing device 110, a point of sale (“POS”) terminal 134 associated with a merchant system 130 and/or a web server (not depicted) associated with a payment processing system 140.

In an example embodiment, the web browser 114 can enable the first user 101 to interact with web pages using the user computing device 110.

In an example embodiment, the user interface 115 enables the first user 101 to interact with the hands-free payment application 116 and/or web browser 114. For example, the user interface 115 may be a touch screen, a voice-based interface or any other interface that allows the first user 101 to provide input and receive output from an application or module on the user computing device 110. In an example embodiment, the first user 101 interacts via the user interface 115 with the hands-free payment application 116 and/or web browser 114 application to configure user accounts on a payment processing system hands-free module 141. In another example embodiment, the first user 101 interacts via the user interface 115 with the hands-free payment application 116 and/or the web browser 114 application to enable hands-free payments, if needed.

In an example embodiment, the GPS module 118 communicates with one or more satellites of the Global Positioning System (“GPS”) or other satellite-based location system to determine the location of the user computing device 110. In an example embodiment, the delivery system 140 periodically or continuously communicates with the GPS module 118 during applicable time periods to determine and log the location of the user computing device 110. In another embodiment, the location of the user computing device 110 is identified based on Wi-Fi signals, cellular location, or any suitable location identifying technology.

In an example embodiment, the hands-free payment application 116 is a program, function, routine, applet, or similar entity that exists on and performs its operations on the user computing device 110. In certain example embodiments, the first user 101 must install the hands-free payment application 116 and/or make a feature selection on the user computing device 110 to obtain the benefits of the techniques described herein. In an example embodiment, the first user 101 may access the hands-free payment application 116 on the user computing device 110 via the user interface 115. In an example embodiment, the hands-free payment application 116 may be associated with the payment processing system 140. In another example embodiment, the application may be associated with the merchant system 130. In yet another example embodiment, there are two applications 116, one associated with the merchant system 130 and another associated with the payment processing system 140.

In certain example embodiments, one or more functions herein described as performed by the hands-free payment application 116 may also be performed by a web browser 114 application, for example, a web browser 114 application associated with a merchant system website 134 or associated with the payment processing system 140. In certain example embodiments, one or more functions herein described as performed by the hands-free payment application 116 may also be performed by the user computing device operating system. In certain example embodiments, one or more functions herein described as performed via the web browser 114 may also be performed via the hands-free payment application 116.

In an example embodiment, the user computing device 110 communicates with the merchant system 130 and the payment processing system 140 via the network 120.

An example merchant system 130 comprises a server 133, POS terminal 134, and a data storage unit 132. In an example embodiment, the merchant system 130 communicates with a payment processing system 140 over the network 120. In example embodiments described herein, the merchant system 130 is a separate entity from the payment processing system 140. However, in certain other example embodiments, the merchant system 130 is associated with a payment processing system 140, is a component of another system along with a payment processing system 140, comprises a payment processing system 140, or is a component of a payment processing system 140.

In an example embodiment, the data storage unit 132 comprises a local or remote data storage structure accessible to the merchant system 130 suitable for storing information. In an example embodiment, the data storage unit 132 stores encrypted information, such as HTML5 local storage.

In an example embodiment, the web server 133 provides content accessible by the first user 101 through the web browser 114 and/or hands-free payment application 116 on the user computing device 110, including but not limited to html documents, images, style sheets, and scripts. In an example embodiment, the server 133 supports the merchant system website 134.

In an example embodiment, the POS terminal 134 comprises a computing device that is configured to accept payments from users 101, from user computing devices 110, or other parties. The POS terminal 134 may communicate, via the network, with the user computing device 110, the merchant server 133, the merchant computing device 150, the payment processing system 140, or any suitable device or system. The POS terminal 134 may comprise a barcode scanner, a user interface, a customer display, or any suitable elements to enable the salesperson 102 to initiate and conduct a transaction. The POS terminal 134 in the example embodiments may comprise a function enabling the salesperson 102 to input an indication that the transaction was conducted with the hands-free application 156 on the merchant computing device 150, and that the POS terminal 134 should consider the transaction completed.

An example payment processing system 140 comprises a payment processing system hands-free module 141 and a data storage unit 142. In an example embodiment, the user 101 has a user account with the payment processing system 140. In an example embodiment, the payment processing system hands-free module 141 manages the user account. For example, the payment processing system hands-free module 141 may receive a user's username and password and allow the user 101 to access services provided by the payment processing system 140. In an example embodiment, the payment processing system hands-free module 141 communicates with the hands-free payment application 116 resident on the user computing device 110. In another example embodiment, the payment processing system hands-free module 141 communicates with the user 101 via the user computing device web browser 114. In an example embodiment, the payment processing system hands-free module 141 manages the user's digital wallet account.

In an example embodiment, the payment processing system hands-free module 141 communicates with the merchant system 130, account issuer systems (not depicted) and/or acquirers (not depicted), or other suitable financial systems (not depicted) to process payments. In an example embodiment, the payment processing system hands-free module 141 retrieves user financial account information and credit account information from other financial institutions, from the data storage unit 142, or by communicating with the hands-free payment application 116 over the network 120. In an example embodiment, the payment processing system hands-free module 141 requests a credit authorization from an issuer system through an acquirer system and receives the credit authorization. In an example embodiment, the payment processing system hands-free module 141 initiates a bank transfer with a financial institution system. In an example embodiment, the payment processing system hands-free module 141 receives the bank transfer or completes the credit card transaction associated with the credit card authorization.

In certain example embodiments, the payment processing system hands-free module 141 creates tokens, verifies tokens, verifies rescue codes, and performs other actions as described herein. In an example embodiment, the payment processing system hands-free module 141 generates a receipt of a transaction and transmits the receipt to the user computing device 110.

In an example embodiment, the data storage unit 142 comprises any local or remote data storage structure accessible to the payment processing system hands-free module 141 suitable for storing information. In an example embodiment, the data storage unit 142 stores encrypted information, such as HTML5 local storage. In an example embodiment, the data storage unit 142 stores user financial account information and/or user credit account information.

An example merchant computing device 150 comprises a data storage unit 152, a communication application 153, a web browser 154, a user interface 155, and a hands-free payment application 156.

In an example embodiment, the data storage unit 152 comprises a local or remote data storage structure accessible to the merchant computing device 150 suitable for storing information. In an example embodiment, the data storage unit 152 stores encrypted information, such as HTML5 local storage.

In an example embodiment, the salesperson 102 uses a communication application 153, such as a web browser 154 application or a stand-alone hands-free payment application 116, to view, download, upload, or otherwise access documents or web pages via a distributed network 120.

In an example embodiment, the communication application 153 can interact with web servers or other computing devices connected to the network 120, including the merchant POS terminal 134, a web server 133 associated with a merchant system 130 and/or a payment processing system hands-free module 141.

In an example embodiment, the web browser 154 can enable the salesperson 102 to interact with web pages using the merchant computing device 150. In an example embodiment, the salesperson 102 is able to access transaction information form the POS terminal 134, and access user account information from the user computing device and the payment processing system hands-free module 141.

In an example embodiment, the user interface 155 enables the salesperson 102 to interact with the hands-free payment application 156 and/or web browser 154. For example, the user interface 155 may be a touch screen, a voice-based interface or any other interface that allows the salesperson 102 to provide input and receive output from an application or module on the merchant computing device 150. In an example embodiment, the salesperson 102 interacts via the user interface 155 with the hands-free payment application 156 and/or web browser 154 application to access a user token to conduct a transaction via the payment processing system 140.

In an example embodiment, the hands-free payment application 156 is a program, function, routine, applet, or similar entity that exists on and performs operations on the merchant computing device 150. In certain example embodiments, the salesperson 102 must install the hands-free payment application 156 and/or make a feature selection on the merchant computing device 150 to obtain the benefits of the techniques described herein. In an example embodiment, the salesperson 102 may access the hands-free payment application 156 on the merchant computing device 150 via the user interface 155. In an example embodiment, the hands-free payment application 156 may be associated with the merchant system 130. In another example embodiment, the application may be associated with the payment processing system 140. In yet another example embodiment, there are two applications 156, one associated with the merchant system 130 and another associated with the payment processing system 140.

In certain example embodiments, one or more functions herein described as performed by the hands-free payment application 156 may also be performed by a web browser 154 application, for example, a web browser 154 application associated with a merchant system website 134 or associated with the payment processing system 140. In certain example embodiments, one or more functions herein described as performed by the hands-free payment application 156 may also be performed by the merchant computing device operating system. In certain example embodiments, one or more functions herein described as performed via the web browser 154 may also be performed via the hands-free payment application 156.

In certain example embodiments, the merchant computing device 150 may be part of the merchant system. The merchant computing device functions described herein may be performed by the merchant server 133, POS terminal 134, or other merchant device without a separate merchant computing device being utilized.

It will be appreciated that the network connections shown are example and other means of establishing a communications link between the computers and devices can be used. Moreover, those having ordinary skill in the art having the benefit of the present disclosure will appreciate that the user computing device 110, the merchant system 130, the POS terminal 134, the payment processing system 140, and the merchant computing device 150 illustrated in FIG. 1 can have any of several other suitable computer system configurations. For example, a user computing device 110 embodied as a mobile phone or handheld computer may or may not include all the components described above.

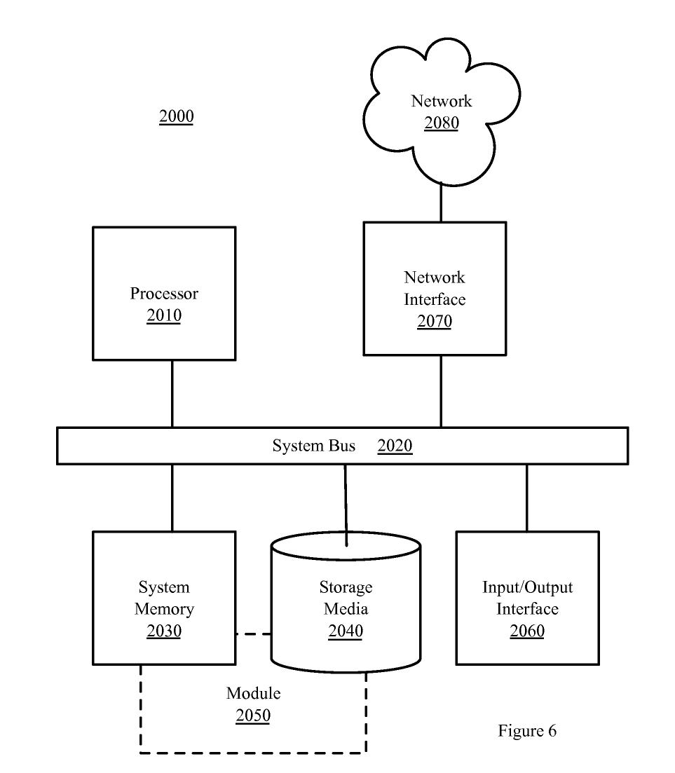

In example embodiments, the network computing devices and any other computing machines associated with the technology presented herein may be any type of computing machine such as, but not limited to, those discussed in more detail with respect to FIG. 6. Furthermore, any functions, applications, or modules associated with any of these computing machines, such as those described herein or any others (for example, scripts, web content, software, firmware, or hardware) associated with the technology presented herein may by any of the modules discussed in more detail with respect to FIG. 6. The computing machines discussed herein may communicate with one another, as well as with other computing machines or communication systems over one or more networks, such as network 120. The network 105 may include any type of data or communications network, including any of the network technology discussed with respect to FIG. 6.

### Example Processes

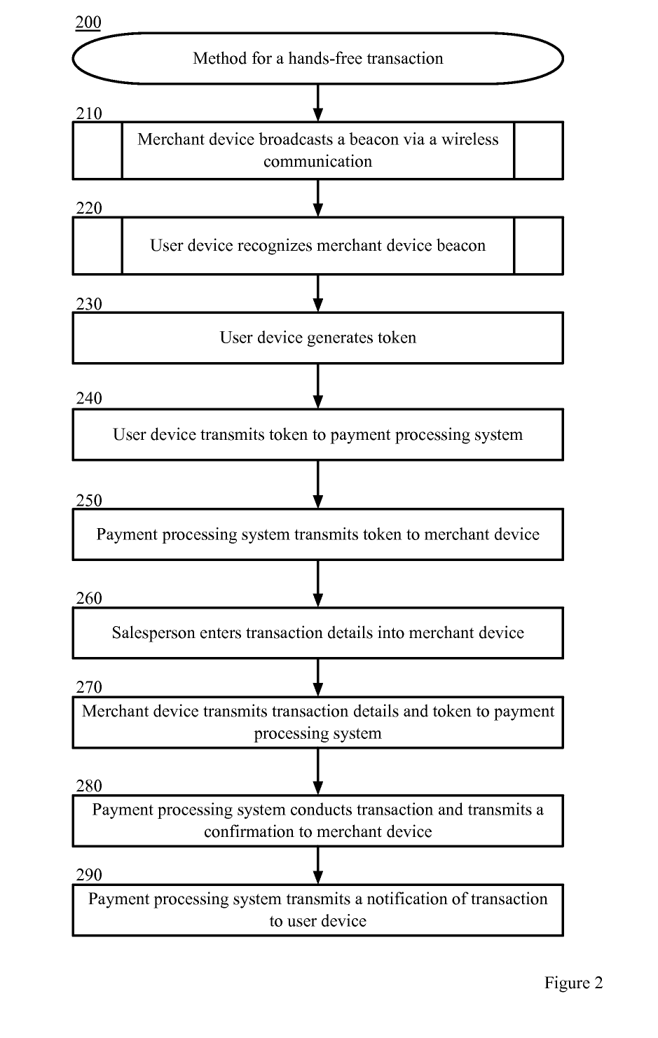

The example methods illustrated in FIGS. 2-5 are described hereinafter with respect to the components of the example operating environment 100. The example methods of FIGS. 2-5 may also be performed with other systems and in other environments.

FIG. 2 is a block diagram depicting a method 200 for conducting a hands-free transaction, in accordance with certain example embodiments. The method 200 is described with reference to the components illustrated in FIG. 1.

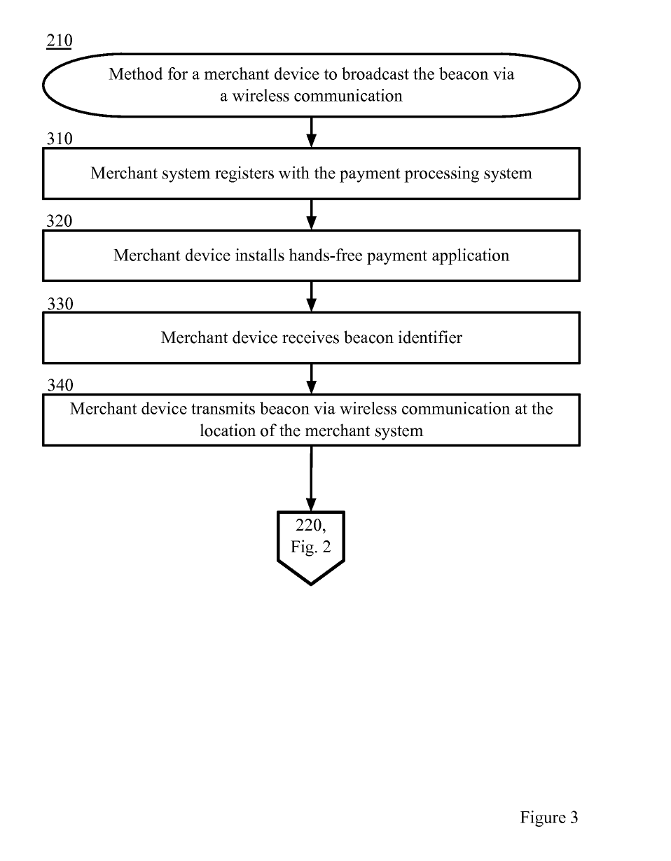

In block 210, the merchant computing device 150 broadcasts a beacon via a wireless communication. Block 210 is described in more detail hereinafter with reference to the method 210 described in FIG. 3.

FIG. 3 is a block diagram depicting a method 210 for a merchant computing device 150 to broadcast a beacon via a wireless communication, in accordance with certain example embodiments. The method 210 is described with reference to the components illustrated in FIG. 1.

In block 310, the merchant system 130 registers with the payment processing system 140. For example, the merchant system 130 may contact the payment processing system 140 to become associated with the hands-free transaction process. The merchant system 130 may obtain a merchant account, receive the appropriate applications and software, request authorization to participate, or perform any action required by the payment processing system 140.

In block 320, the merchant computing device 150 installs a hands-free payment application 156. In an example, the merchant computing device 150 is registered as an authorized agent of the merchant system 130. The merchant computing device 150 may be identified by an identifier, by a provided password, or by any suitable manner.

The merchant computing device 150 downloads the hands-free payment application 156 from the payment processing system hands-free module 141 over the network 120. The merchant computing device 150 may download the hands-free payment application 156 from the merchant system server 133. The merchant computing device 150 may obtain the hands-free payment application 156 from any suitable location. The hands-free payment application 156 on the merchant computing device 150 may be integrated into an existing account that is shared with the merchant system server 133, the POS terminal 134, or any suitable computing device or system.

In block 330, the merchant computing device 150 receives a beacon identifier. For example, the hands-free payment application 156, the merchant computing device 150, the merchant system server 133, or another computing device requests a beacon identifier from the payment processing system 140. The beacon may be a wireless signal emitted by the merchant computing device 150 comprising a beacon identifier, a merchant computing device 150 identifier, or other identifier. In an example, the beacon identifier may be a service set identifier (“SSID”), or other network name or identifier. The beacon identifier may be generated by the payment processing system hands-free module 141, the merchant computing device 150, the merchant server 133, or any suitable computing device. The wireless signal emitted by the merchant computing device 150 may be any suitable technology, such as Wi-Fi direct, Bluetooth, low-energy Bluetooth, infrared, or any other suitable technology, and the merchant computing device 150 can include corresponding hardware and software components to emit the beacon via the associated technology.

In block 340, the merchant computing device 150 transmits the beacon via wireless communication at the location of the merchant system 150. The merchant computing device 150 may be configured to broadcast the wireless signal at only certain times or continuously. The merchant computing device 150 may limit or extend the strength of the broadcast beacon, if needed. The beacon is receivable and recognizable by other computing devices that are within range of the wireless signal.

In a certain example embodiment, the beacon identifier is programmed on external communication access points. The merchant hands-free application 156 may be used to configure the external communication access point(s). The external communication access points may be employed to allow a variety of user computing devices 110 to receive the beacon despite differing wireless communication technology capabilities or in various locations in the merchant location.

From block 340, the method 210 proceeds to block 220 of FIG. 2.

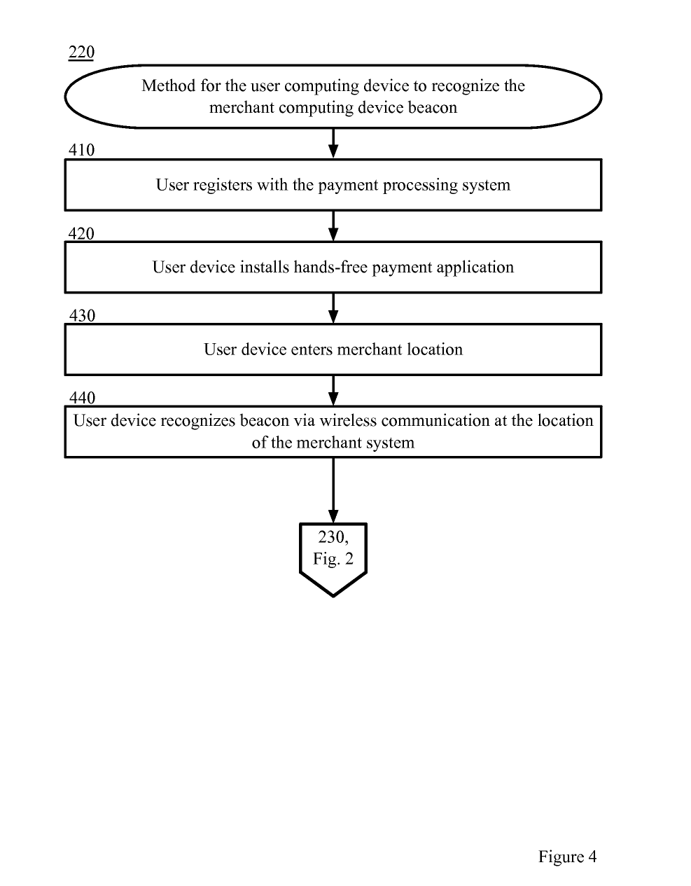

Returning to FIG. 2, in block 220, the user computing device 110 recognizes the merchant computing device beacon. Block 220 is described in more detail hereinafter with reference to the method 220 described in FIG. 4.

FIG. 4 is a block diagram depicting a method 220 for the user computing device 110 to recognize the merchant computing device beacon, in accordance with certain example embodiments. The method 220 is described with reference to the components illustrated in FIG. 1.

In block 410, the user 101 registers with the payment processing system 140. For example, the user 101 may contact the payment processing system 140 to register a user account. The user 101 may obtain a user account number, receive the appropriate applications and software to install on the user computing device 110, request authorization to participate in the hands-free payment processing, or perform any action required by the payment processing system 140. The user 101 may utilize the functions of the user computing device 110, such as the user interface 115 and the web browser 114, to register a user account.

In block 420, the user computing device 140 installs a hands-free payment application 116. For example, the user computing device 110 downloads the hands-free payment application 116 from the payment processing system hands-free module 141 over the network 120. The user computing device 110 may obtain the hands-free payment application 116 from any suitable location. The hands-free payment application 116 on the user computing device 110 may be configured with the user account information or other suitable information.

The hands-free payment application 116 may comprise a listing of participating merchant systems 130 and merchant locations. The listing may be updated periodically from the payment processing system 140. The hands-free payment application 116 may notify the user 101 when the user 101 is within a configured vicinity of a participating merchant system 130. The hands-free payment application 116 may provide the user 102 with options to update payment preferences. The hands-free payment application 116 may provide the user 101 with a listing of recent transactions. The hands-free payment application 116 may provide any suitable information to the user 101.

In block 430, the user computing device 110 enters the location of the merchant system 130. The user 101 may enter the merchant location carrying the user computing device 101 in a pocket or a bag, in the hands of the user 101, or in any suitable manner. The location of the merchant system 130 may be a store location, a kiosk location, or any suitable physical location of a merchant system 130.

In certain example embodiments, the hands-free payment application 116 alerts the user 101 when the user 101 is in the vicinity of a merchant system 130 that accepts hands-free payments. The alert may be provided via a message on the user computing device 110, via an email or a text, or in any suitable manner.

The alert may be based on the location of the user 101 as determined by the GPS module 118. For example, the hands-free payment application 116 accesses the GPS data from the GPS module 118 and compare the GPS location to a list of locations of merchant systems 130 that accept hands-free payments. If a match results from the comparison, then an alert is generated and provided to the user. The match may result if the user 101 is within a configured distance of the merchant system 130.

The alerts may be configured to alert in a configured manner. In an example, the alerts may be combined in commercially dense environment or the alerts may be presented individually. In another example, the alerts may be configured to only alert the user 101 a configured number of times. For example, the alert may be presented three times, but upon a fourth instance, the alert is not presented. The alerts may be presented as a notification with an audible alert, a vibration, or other alert.

In block 440, the user computing device 110 recognizes a beacon via wireless communication at the location of the merchant system 150. The user computing device 110 may be configured to search for beacons or other wireless signals. Upon entering the range of the signal of the merchant computing device 130, the user computing device 110 receives the beacon. The user computing device 110 interprets the data transmitted in the beacon and recognizes that the beacon is associated with the payment processing system 140 and the hands-free payment application 116. The user computing device 110 may compare the data from the beacon to a database of beacon data to determine an identity of the merchant system 130 associated with the beacon and to verify the authenticity of the beacon.

The hands-free payment application 116 interprets the data that is provided in the beacon. For example, the hands-free payment application 116 extracts data from the beacon, such as a beacon identifier, a merchant system name, communication technology requirements, or any other suitable information.

In certain example embodiments, the hands-free payment application 116 has received a list of one or more merchant systems 130 with which the user 101 does not wish to conduct hands-free transactions. If the hands-free payment application 116 identifies the merchant system 130 on the list, then the hands-free payment application 116 will not respond to the beacon identifier. In this case, hands-free payment application 116 may end any wireless communication with the merchant computing device 150 and not provide any response or acknowledgement to the merchant computing device 150 while the user computing device 110 is a the location of the merchant system 130.

From block 440, the method 220 returns to block 230 of FIG. 2.

Returning to FIG. 2, in block 230, the user computing device 110 generates a token for a potential transaction. The token may be any data associated with the user account that is generated by the user computing device 110 for secure transmission to another computing device. The token may represent an authorization or acknowledgement by the user computing device 110 that the user computing device 110 is in communication with a merchant computing device 110 and that a transaction may be forthcoming. The token may comprise a user account identifier, the beacon identifier, a user computing device 110 identifier, or any suitable data. The token may be encrypted or otherwise configured to only be readable by one or more of the payment processing system hands-free module 141, the user computing device 110, a financial account server associated with the payment processing system 140, or any suitable computing system. In certain example embodiments herein, the token, or certain portions of the token, is not readable by the merchant computing device 150. To generate the token, the user computing device 110 may compile all of the data needed for the token into a data file and include identifiers, labels, or other items to prepare the token for transmission.

The token may provide a time that the token will expire. For example, the token may only be usable for 1 hour after being generated. In the example, after the 1 hour has elapsed, the token is no longer valid for use. In certain example embodiments, the token comprises the beacon identifier, the location of the user computing device 110, the user account identifier, or any other suitable data.

The token may be generated by the hands-free application 116, or another function of the user computing device 110. For example, an application operating on a secure element of the user computing device 110 may generate the token.

In block 240, the user computing device 110 transmits the token to the payment processing system hands-free module 141. The user computing device 110 may transmit a new token at the time that the user computing device 110 recognizes the beacon and the beacon identifier, at a time that a previous token has expired, or upon any suitable schedule. The user computing device 110 may transmit the token via an Internet communication over the Internet or via any suitable connection.

In block 250, the payment processing system hands-free module 141 transmits the token to merchant computing device 150. The payment processing system hands-free module 141 receives the token and any associated information from the user computing device 110 and determines if the beacon identifier can be verified. For example, the payment processing system hands-free module 141 may compare the beacon identifier to a database to determine if the beacon identifier is registered and approved. The payment processing system hands-free module 141 may compare a location of the user computing device 110, as determined by the global positioning system (“GPS”) module 118, to a database of locations associated with the beacon identifiers. The payment processing system hands-free module 141 may request the GPS location of the user computing device 110 in a communication over the network 120 and receive a response from the user computing device 110. If the location of the user computing device 110 matches the expected location of the merchant computing device 150, then the token is verified. Any other suitable criteria for verifying the token may be employed.

The payment processing system hands-free module 141 may verify the user account on the payment processing system 140 to determine if the user account is active and available for transactions. For example, the payment processing system may access the user account and determine if the account has funds available for use as stored value funds, or if the account has a valid credit account associated with the account.

If the token is verified, the payment processing system hands-free module 141 communicates the token to the merchant computing device 150. The token provides the merchant computing device 150 the authorization to initiate a transaction on behalf of the user account.

In block 260, the salesperson 102 enters transaction details into merchant computing device 150. In an example, the user 101 selects a product for purchase at the location of the merchant system 130. The term “product” includes tangible as intangible products, as well as services. The salesperson 102 scans the product with a barcode scanner or in any suitable manner enters the product details into the merchant computing device 150. The transaction data may include the product identification, the product price, or any other suitable information.

In block 270, the merchant computing device 150 transmits the transaction details and the token to the payment processing system hands-free module 141. The salesperson 102 identifies the user account from the token and associates the user account with the product being purchased by the user 101. The user account may be represented to the salesperson 102 by a picture of the user 101, by a name of the user 101, by a configured alias, or by any suitable identifier of the user 101 or the user account. The salesperson 102 provides an indication on the user interface 155 of the merchant computing device 150 that the user 101 has agreed to the purchase transaction. The merchant computing device 150 transmits the transaction details and the token to the payment processing system hands-free module 141 to conduct the transaction.

In block 280, the payment processing system 140 conducts the transaction and transmits a confirmation to merchant computing device 150. Alternatively, the processing system 140 The payment processing system hands-free module 141 receives the transaction details and the token from the merchant computing device 150 and authorizes and processes the transaction. The payment processing system hands-free module 141 verifies the token as the same token that was previously received from the user computing device 110 and provided to the merchant system computing device 150. If the token is not verified as the same token, then the transaction does not proceed. If the token is not verified, the payment processing system hands-free module 141 may request the correct token from the merchant system computing device 150, cancel the transaction, alert a payment processing system hands-free module 141 operator, or perform any suitable action.

To process the transaction, the payment processing system hands-free module 141 determines if the user account has the funds available for the transaction. In an example, if the funds are available and the token is verified, then the payment processing system authorizes the transaction or perform any other exchange between the user computing device and the merchant computing device. The payment processing system hands-free module 141 may apply the transaction by deducting the amount of the transaction from a pool of funds stored in the user account. In another example, the payment processing system hands-free module 141 may provide an authorization request to a financial account issuer, such as a credit card, associated with the account. Upon receiving an authorization from the financial account issuer, the payment processing system hands-free module 141 proceeds with the transaction. The user account may be funded by any other suitable source, such as a bank account, a stored value account, a debit card, or any suitable source.

The payment processing system hands-free module 141 provides a notification to the merchant system computing device 150 that the transaction is authorized. Upon receiving the authorization, the salesperson 102 may provide the product and a receipt to the user 101 or the user computing device 110. Upon settlement of the transaction, the payment processing system hands-free module 141 provides the funds for the transaction to the merchant system 130.

In block 290, upon a successful conducting of the transaction, the payment processing system 140 transmits a notification of the transaction to the user computing device 110. The notification allows the user 101 an opportunity to quickly dispute the charge. For example, the salesperson 102 or the merchant computing device 150 may have associated the wrong token with the transaction details. In another example, the transaction details were in error and an incorrect amount was deducted from the user account. The user 101 receives the notification on the user computing device 110 and views the details on the user interface 115. In an alternate example, the user 101 receives the notification as an email, a text, as a notification on the hands-free payment application, or in any suitable manner.

All refunds for transactions may be conducted through the hands-free application 116. The user 101 initiates the hands-free application at the location of the merchant 130. The user 101 presents a transaction identification and a receipt to complete the refund. The refund may either present the receipt via the hands-free application 116, an email receipt, or a print out of the email receipt.

To obtain a refund, a user 101 opens a list of transactions on the hands-free application 116 and selects the desired receipt. Additionally, the user 101 may manually enter the transaction identification or scan a QR code on the receipt displayed on the hands-free application. The user 101 may access a list of recent transactions and on the user computing device 110. The list may be displayed on a user interface 115 with control objects for selecting a transaction. The user computing device 110 can receive an input of a selection from the user 101 and transmits the details of the selected transaction to the merchant system computing device 150.

Once selected, a full or partial amount can be refunded to the user account. The merchant system 130 may transfer the refund amount to the payment processing system 140 for deposit into the user account. The funds may alternatively be transmitted by the merchant system 130 or the payment processing system 140 to a credit card account or other account associated with the user account. Any other refund method may be employed. The transaction history and receipt in the user account will reflect the full or partial refund.

If a user 101 desires to dispute a charge, the user 101 opens the hands-free application 116 and selects an option to dispute a transaction that has been conducted with the user account. The hands-free application 116 transmits a notification to the payment processing system hands-free module 141. An operator at the payment processing system 140 may contact the user 101 to resolve the issue. The hands-free application 116 may further transmit the transaction identification or other transaction details to the payment processing system hands-free module 141.

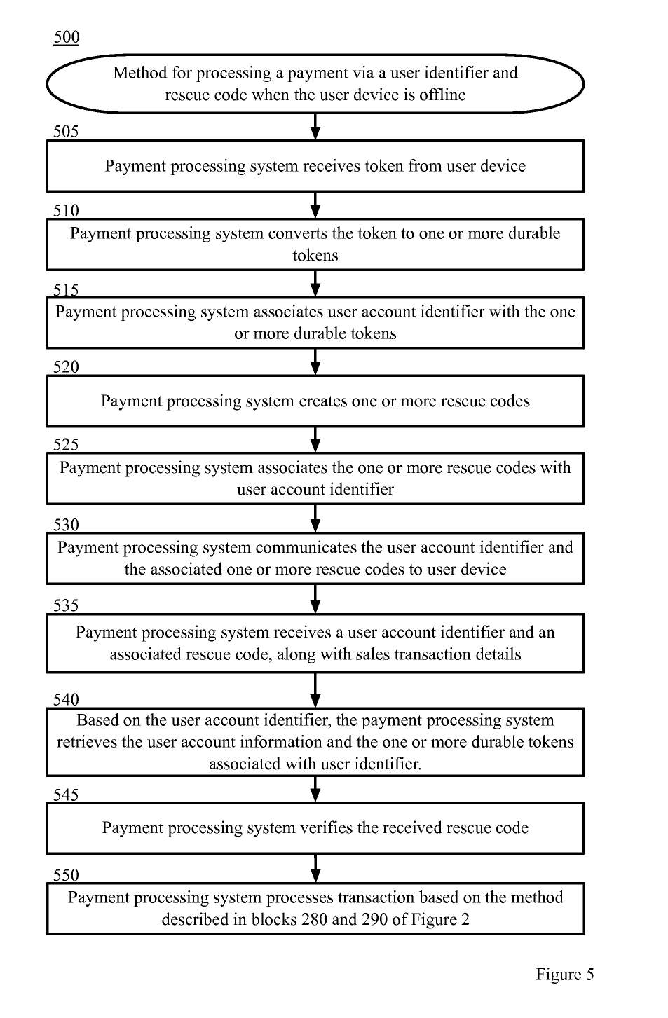

Turning to FIG. 5, in certain example embodiments, the user computing device 110 may not be able to connect to the network 120 when the user computing device 110 is at a location associated with the merchant system 130. For example, the user 101—and the accompanying user computing device 110—may be at a remote, merchant location where a connection to the network 120 for the user computing device 110 is unavailable. In this case, the user 101 and a salesperson 102 with a merchant computing device 150 may need to rely on the methods provided in FIG. 5 to complete a sales transaction.

FIG. 5 is a block diagram depicting a method 500 for processing a payment via a user identifier and rescue code, such as when the user computing device 110 is unable to connect to the network 120, in accordance with certain example embodiments.

In block 505, the payment processing system 140 receives a token from the user computing device 110, such as at a time when the user computing device 110 is connected to the network 102. For example, the user computing device 110, such as via the hands-free payment application 116, generates a token (a first token) as described herein with reference to block 230 of FIG. 2. When the user computing device 110 is connected to the network 120, the user computing device 110 then transmits the token to the payment processing system 140 via the network 120, such as described in block 240.

In certain example embodiments, the user computing device 110 periodically transmits the token to the payment processing system 140 when the user computing device 110 is connected to the network 120 (or online). For example, the user computing device may transmit the token to the payment processing system 140 once per day, every other day, every three days, or once a week. The payment processing system 140 then receives the transmitted token, such as via the network 120.

In block 510, after receiving the token, the payment processing system 140 converts the received token to one or more “durable” tokens (a second token, for example). That is, the payment processing system 140 creates one or more tokens that remain valid longer than the originally received (first) token. For example, in certain example embodiments, the originally received token may last only a few hours, an hour, or a fraction of an hour. The durable tokens, however, may remain valid for 24 hours or longer, such as 2-3 days, a week, or two weeks, for example. After creating the one or more durable tokens, the payment processing system 140 may associate the one or more durable tokens with the data storage unit 142 of the payment processing system so that the payment processing system 140 can later access the one or more durable tokens.

In certain example embodiments, the one or more durable tokens may be associated with additional features that increase the security of the durable tokens. For example, a durable token may be associated with an encryption key that is specific to each user 101 (not a service key). Additionally or alternatively, the one or more durable tokens may include or be associated user account information that is specific to each user 101. For example, a durable token may be associated with the user account information of the user, such as the user's account log in information, and hence be verifiable against the user's, user-specific account information.

To eliminate or reduce risk that may exist with persistent token storage, the payment processing system 140 may, in certain example embodiments, limit the number of global transactions that use rescue codes per day or other configurable time period. Additionally or alternatively, the payment processing system 140 may limit the number of transactions that use rescue codes from a particular merchant system 130 per day or other configurable time period.

In block 515, the payment processing system 140 associates the user account identifier with the one or more durable tokens. For example, when establishing a user account, the payment processing system 140 may create a user account identifier for a particular user 101 that specifically identifies the user 101 associated with the account. In certain example embodiments, the user account identifier may include the account name, such as the user name associated with the account. Additionally or alternatively, the user account identifier may include all or part of the telephone number of the user 101, such as the last four digits of a user's telephone number. Additionally or alternatively, the user account identifier may include all or part of the user's initials. Additionally or alternatively, the user account identifier may be a unique set of numbers or characters, derived from the user account information, that identify the specific user account of a particular user 101.

In certain example embodiments, the payment processing system 140 may encode a 12 decimal digit code (5 digits for user account identifier, 1 digit for C % 10 and 6 digits for the one time password code, where “C” is a shared random counter between every user computing device 110 and the authenticator of the payment processing system 140) using 8 base 33 digits (all alphabets except i, l and o, and 0-9).

In certain example embodiments, the user account identifier may be 5, 6, 7, 8, 9, 10, or more alphanumeric characters. In certain example embodiments, the payment processing system 140 may assign unique, random identifiers for the user account identifier within the number space of N digits (N=5 for the first 100K users, for example). After that, the payment processing system 140 can make N># digits to represent the total # of expected users. In certain example embodiments, Reed-Solomon codes may be used to maximize an edit distance between user account identifiers so that a typographic error reduces the likelihood of charging the wrong user.

In block 520, the payment processing system 140 creates one or more rescue codes for the user 101. That is, the payment processing system 140 establishes and generates one or more codes that the user 101 can employ at a merchant location to complete a transaction when the user computing device 110 is unable to connect to the network 120. The one or more rescue codes can be any set of numbers, letters, or characters that are assigned to a particular user 101.

In certain example embodiments, the rescue code may include a 7-digit code. For example, the most significant digit may be C % 10. Including a C % 10, for example, allows toleration of a counter skew of 10 without accepting any invalid codes. As such, the payment processing system 140 can tolerate a greater counter skew of N*10, if the payment processing system 140 is willing to increase the probability of an incorrect code by N. The remaining 6 digits in such examples represent the code, such as a one-time-password (“OTP”) code, that the authenticator checks against all devices that the user may have enrolled. As such, there may a 1 in 83,333 chance of guessing an OTP (because 12 out of 1 million OTPs are valid) with the following parameters: (i) A user account has enrolled in 4 devices; (ii) the tolerance is a clock skew of +/−1 time quantum (that is, 3 time quanta are checked); (iii) a maximum counter of skew of 10 is accepted; and, (iv) 12 out 1 million OTPs are valid.

If the payment processing system 140 uses a 6-digit code without including any bits from the counter, for example, the payment processing system 140 cannot accept any counter skew. This will result in many false negatives—that is, the code is a valid code but the user 101 may only need to open the application at least once to retrieve the counter but not pass it to the payment processing system 140. In certain example embodiments, if the payment processing system 140 relies on a 6-digit code and sets the most significant digit to C % 10 (for a counter skew tolerance of 10), there is a 1 in 8,333 chance of guessing an OTP. In certain example embodiments, if the payment processing system 140 uses the last 6 digits of the code with no counter prefix and accepts a counter skew of N, the payment processing system 140 allows an N in 83,333 chance of guessing an OTP.

In certain example embodiments, the digits other than the C % 10 may be increased in number, such as to 8, 9, or 10 digits, thereby decreasing the likelihood that an unauthorized individual may guess or determine a particular rescue code. For example, if the payment processing system 140 increases the OTP length to 8 digits (that is, the first two digits are C % 100) but limits the counter skew to 10, there is an N in 333,333 chance of guessing an OTP where N is the number of devices whose C % 100 is behind the user's C % 100 by at most 10.

By contrast, in certain example embodiments the payment processing system 140 may issue 10 rescue codes that are valid forever and give an N in 100,000 chance of a successful random guess, where N is the number of devices enrolled for the given user

account. For example, the payment processing system 140 may create 10 rescue codes as follows:

IV = Secure Random IV.
for i in 1..10 do
rescue_code[i] = HMAC(K, IV | Transact-Dat | i) >> 20;
Write {obfuscate(user's phone number): [IV, obfuscated_user_gaia, 1]}
as {key: value}
Return rescue_code[1..10] to user computing device.

In certain example embodiments, an operator of the payment processing system 140 may want to limit the total number of digits that a user communicates to the salesperson 102 (as described herein) to 6 or 7 digits. Hence, the payment processing system 140 uniquely identifies a user using these digits and any additional information that the payment processing system 140 can implicitly derive, such as without the user 101 communicating this information. The derived attributes may include time and/or user location as described herein.

With regard to time (modulo clock synchronization errors), in certain example embodiments, there may be more than 10 million users. Hence, 7 digits may not be sufficient to uniquely identify a user 101 even if the payment processing system 140 determines the transaction time because any of the more than 10 million users could be transacting at any time.

With regard to location, in certain example embodiments, such as when fewer digits are desired, the payment processing system 140 may employ the salesperson's 102 approximate location as a proxy for the user's approximate location. The payment processing system 140 can use the approximate location to partition the users into disjoint buckets. For example, the payment processing system 140 can partition the world into geo regions.

In certain example embodiments, the upper bound on the size of each geo region is determined by the maximum number of users 101 that can be within each geo region, factoring in the following assumptions: (1) Assume an operator of the payment processing system 140 wants to provide 10 rescue codes per user; and (2) assume an operator of the payment processing system 140 wants to limit the probability that a malicious user can guess a rescue code to 1 in 1000.

The second assumption limits each geo region to have at most 1000 users. Densely populated areas (such as urban malls) will need to have very small geo regions. As such, rescue codes are valid only in the geo region where they were issued, so the user computing device needs to be frequently online to download a new set of rescue codes when the user crosses geo regions. The flow between the user computing device 110 and the payment processing center 140 server is roughly as follows: (1) user computing device 110 downloads 10 rescue codes; (2) user computing device records the current geo region; (3) user computing device 110 crosses a geo-region (as noted above, the geo-region size depends on population density and could be as small as 0 to 100 meter radius in an urban mall setting; (4) the user computing device 110 device downloads rescue codes valid for the new geo region. Lastly (5), assuming the user computing device 110 is offline when the user 101 is transacting, (a) user computing device 110 requests most recent location; (b) if the most recent location is in the geo region where the rescue code was issued, use the rescue code (note: this still leaves a 1 in 1000 chance that the payment processing system 140 may charge the wrong user 101 if the most recent location in the user computing device 110 of the user 101 and the location of the salesperson 102 are in different geo regions); and (c), if the most recent location is not the geo region where the rescue code was issued, a fail occurs.

To determine the location of a user 101 and or salesperson 102 as described herein within a particular geographic region, the payment processing system 140 may rely on geo-location information of the user computing device 110. For example, the payment processing system 140 may rely on satellites, Global Positioning System (“GPS”) location technology, a Network Location Provider (“NLP”), a map application, or other location identifying technology of the user computing device 110 to determine location history for the user computing device 110. A GPS module 118 in the user computing device 110, for example, may provide location information directly or indirectly (such as via a location-based service) to the payment processing system 140.

Additionally or alternatively, in certain example embodiments, generation of the rescue code may involve a shared, secret exchange between the user computing device 110 and the payment processing system 140 (or another trusted authentication system affiliated with the payment processing system 140 that may, for example, be separate and distinct from the payment processing system 140). In such embodiments, once the shared secret is initially exchanged, the user computing device 110 can create one-time rescue codes without further communication (other than to, possibly, refresh any tokens needed for charge processing as described herein).

For example, installed and operating on the user computing device 110 may be a pre-configured, offline OTP generator or other software application module that is self-contained on the user computing device 110. That is, once installed, the generator can operate even when the user computing device 110 is not connected to the network 120. The generator can be used, for example, to answer login challenges when the user computing device 110 is offline and unable to receive SMS messages, voice calls, or respond to authentication prompts over the network 120. In certain example embodiments, the generator may be part of an application executing on the user device 110, such as the hands-free payment application 116.

As part of the pre-configuration, the user computing device 110 may be pre-registered with the payment processing system 140, for example, using a user's log-in credentials associated with the payment processing system 140. The user computing device 110 may also be provisioned with a per-user, per-device secret S, shared with the payment processing system 140. For example, the payment processing system 140 may provision S using a user device registration protocol. In certain instances, S may be shared Diffie-Hellman secret (either 2048-bit modp DH value, or x-bit ECDH value), rotated every 30 days, for example.

Components of the system may include a counter. For example, the user computing device 110 may be additionally provisioned with a 64-bit counter C along with the secret S. This counter, for example, may be initialized to a random value, and may wrap on overflow. Additional components may include: HKDF, the HMAC-based Extract-and-Expand Key Derivation Function (RFC 5869, incorporated herein); HOTP, the HMAC-Based One Time Password Algorithm (RFC 4226, incorporated herein), a counter-based OTP generator relying on both a key K and a counter C shared between client and server; and, TOTP, the Time-Based One Time Password Algorithm (RFC 6238, incorporated herein), a time-based OTP generator relying on a key K shared between client and server and reasonably synchronized clocks.

For key generation, the payment processing system 140 may use THOTP with HMAC-SHA256, thus using 32 bytes of symmetric keying material K. That key K could be pre-hashed between client and server in any number of ways. For example, the payment processing system 140 may obtain K from another predetermined shared secret S, such as a Diffie-Hellman shared secret set up according to the following rationale:
K=HKDF(salt, info, S), where HKDF is used with SHA256 as the hash function, resulting in a 32-byte K)
salt=SHA256(“DeviceOfflineOTP”)=83b3ca604a0d13bc4cbe7c2cbeb1d11dc472589fda32df51a15697656a386d56 (this is the hex representation of the binary value to be used as the salt)
info=“THOTP”.getBytes(“UTF-8”)
   In such embodiments, OTP generation may employ a hybrid HOTP/TOTP generator with key K and counter C as follows:
Following TOTP, define the current time quantum Tq as: Tq=floor((Current Unix time−T₀)/Qₜ), where: T₀=0 is the start of the Unix epoch (Unix time 0); Current Unix time is the time in seconds since the epoch; Qₜ is a parameter, the length of the time quantum used for TOTP (value described below).
C is a long (64-bit) signed counter value (because Java does not handle unsigned values well). C should be initialized to a random value as part of configuration. The payment processing system 140 may limit the range from 0 to Long.MAX_VALUE (2⁶³−1). If incrementing the counter would move it beyond MAX_VALUE, the payment processing system 140 may wrap it to 0.

To compute the THOTP hash value, the payment processing system 140, for example, may calculate the HMAC-SHA256 of the concatenation of Tq and C, each represented as 8-byte values, hashed high-order byte first (big-endian): H=HMAC-SHA256(K, Tq∥C). The payment processing system 140 may then use as the OTP the value of the counter C % 100 concatenated with a compressed function of H: THOTP(K, C, Tq)=Render(C % 100, H).

For rendering, the Render function can be chosen in a variety of ways. For example, a Render function may result in an 8-decimal digit OTP, and is thus: C % 100∥Truncate(H), where Truncate is a version of the HOTP truncation function adapted for SHA-256, and C % 100 is left-padded with Os so as to always be 2 digits long, for example.

Alternatively or additionally, a Render function may transform an equivalent number of bits (2 decimal digits of C and a 6-decimal digit OTP) into a shorter alphabetic string—6 ASCII characters in base 23 (to avoid i/l/o), similar to an airline record locator, for example. This may have the advantage of being shorter. In such embodiments, the user interface of the user computing device 110 may normally advance the counter C each time the user displayed the OTP. Additionally or alternatively, the user interface of the user computing device 110 may provide one or more options for the user 101 to manually advance the counter when the user 101 needs an additional OTP.

With regard to parameter selection in such embodiments, a Tq of 15 minutes, or 900 seconds, may be employed, allowing a total of 3 time intervals to be valid at any one time (the current time, one interval into the past, and one into the future). Alternatively, a Tq of 20 minutes, 30 minutes, 45 minutes, or an hour may be employed. Further, the HOTP Render function may be employed, with any biases likely not of concern in such embodiments.

Alternatively or additionally, in such embodiments, the payment processing system 140 may rely on standard TOTP or TOTP-SHA-256. Such reliance my be useful, for example, when operators of the payment processing system 140 are not concerned with the additional brute force possibilities incurred by having multiple devices enrolled simultaneously or clock sync issues for offline users. For example, if an operator of the payment processing system 140 wishes to reduce the brute force risk incurred by having multiple devices—and is not concerned that users 101 will cycle devices frequently—the payment processing system 140 can issue each device 101 a small numeric ID that is unique among that user's current devices. The OTP is then the concatenation of the device ID as a prefix and a regular TOTP value. The user's first device could have the ID 0, which could be encoded into the empty prefix, meaning only users with more than one device would be affected by the prefix requirement.

Alternatively or additionally, if an operator of the payment processing system 140 is not concerned with users needing to enter multiple codes within a 30-minute window, payment processing system 140 may use TOTP or device ID-prefixed TOTP with the 30-minute Tq suggested above. This serves to limit the brute forcing risk and simplify the UX, for example.

With regard to security in such embodiments, an operator of the payment processing system 140 may assume an 8-digit OTP encoded as described herein. With no allowed counter skew, each of a user's devices 101 may be effectively independent (up to the point where for N devices a random set of N counters will have a collision in its 2 least significant digits). If the payment processing system 140 allows no counter skew, but allows time skew of 3, 30-minute time quanta Tq active at once (current and +/−1), the guessing probability for matching an OTP is 1 in 33M. Even with an increase in allowed counter skew by a factor of 10, and an increase probability of device collision, the guessing bound would still be on the order of 1 in 1M, better than TOTP with an ˜10-interval allowed clock skew. The basic security of THOTP itself should otherwise be governed by the same security derivations from HMAC used to argue for HOTP and TOTP.

In block 525, the payment processing system associates the one or more rescue codes with user account identifier of the user 101. That is, for example, once the payment processing system 140 establishes one or more rescue codes for a particular user 101, the payment processing system 140 records the one or more rescue codes in the user account associated with user 101, or in a record that associates the one or more rescue codes with the user account, thereby associating the one or more rescue codes with the user account identifier.

In block 530, the payment processing system 140 communicates the user account identifier and the associated one or more rescue codes to user computing device 110. That is, the payment processing system 140 transmits the user account identifier and associated one or more rescue codes to the user computing device 110, such as via the network 120, and the user computing device 110 receives the user account identifier and associated one or more rescue codes. The user computing device 110 can then store the user account identifier and associated one or more rescue codes, such as in the data storage unit 112 of the user computing device 110 for later use with a sales transaction as described herein.

In block 535, the payment processing system receives a user account identifier and an associated rescue code, along with sales transaction details for a sales transaction between a user 101 and a salesperson 102. That is, as described herein, a user 101 may not—in certain situations—be able to connect the user computing device 110 to the network 120 in some instances. Hence, the user 101 may be unable to process a merchant transaction as described herein with reference to FIGS. 2-4. As such, the user 101 may rely on the user account identifier and the associated one or more rescue codes stored on the user computing device 110 to process the transaction with a salesperson 102.

For example, to rely on the user account identifier and the associated rescue codes stored on the user computing device 110 to process the transaction, the user 101 presents the user account identifier and one of the associated rescue codes to a salesperson 102. In certain example embodiments, the salesperson 102 may manually input or enter the user account identifier and/or the rescue code into the merchant device 150, such as by viewing the user account identifier and/or the rescue code on a user interface of the user computing device 110 and then inputting the user account identifier and/or the rescue code into the into the merchant device 150.

Alternatively or additionally, the merchant device 150 may receive the user account identifier and/or the rescue code by electronic means, such as via Bluetooth, Bluetooth low energy, near field communication (“NFC”), Wi-Fi (such as Wi-Fi direct), infrared, or any combination thereof. In other example embodiments, the user account identifier and/or the rescue code may be embedded in a bar code or Quick Response Code (“QR”) code that the user 101 presents via the user interface to the salesperson 102 for scanning By scanning the bar code or the QR code, the salesperson 102 inputs the user account identifier and/or the associated rescue code into the merchant device 150.

Once the user account identifier and the associated rescue code are entered into the merchant device 150, the merchant device 150 transmits the user account identifier and the associated rescue code to the payment processing system 140 via the network 120. In addition to the user account identifier and the associated rescue code, the merchant device 150 transmits transaction details to the payment processing system 140 via the network 120, such as the transaction details discussed herein in blocks 260 and 270. The payment processing system 140 then receives the user account identifier and the associated rescue code via the network 120, along with the transaction details for the transaction.

In certain example embodiments, the merchant device 150 may indirectly transmit the user account identifier, the associated rescue code, and/or the transaction details to the payment processing system 140 via that merchant system 130. For example, the merchant device 150 may first transmit the user account identifier, the associated rescue code, and/or the transaction details to the merchant system 130 via the network 120. The merchant system 130 then transmits the user account identifier, the associated rescue code, and/or the transaction details to the payment processing system 140 as described herein via the network 120.

In block 540, based on the user account identifier, the payment processing system 140 retrieves the user account information and the one or more durable tokens associated with user identifier. That is, using the user account identifier, the payment processing system 140 locates the user's account information, along with the one or more durable tokens associated with user account. For example, the payment processing system 140 compares the received user account identifier to a record of user accounts to locate the record for the user account corresponding to the particular user account identifier. Once the user account is located, the payment processing system 140 can then identify the durable tokens associated with the user account identifier.

In block 545, the payment processing system verifies the received rescue code. That is, the payment processing system 140 verifies that the one or more durable tokens is in fact associated with the received rescue code—thereby verifying the authenticity of the transaction between the user 101 and the salesperson 102. In certain example embodiments, the payment processing system may additionally or alternatively verify the received rescue code by re-computing the logic that was used to create the rescue code.

In block 550, based on the verification of the transaction as described in block 540 and 545, the payment processing system 140 processes the transaction, such as based on the method described in blocks 280 and 290 of FIG. 2. That is, the payment processing system 140 completes the transaction on behalf of the user 101.

### Other Example Embodiments

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to complete offline exchanges of information between two computing devices, wherein the exchange requires authentication by a third computing device, comprising:
receiving, by one or more computing devices, a first token associated with a user account from a user computing device, wherein the user computing device is distinct from the one or more computing devices;
in response to receiving the first token, generating, by the one or more computing devices, a second token associated with the user account, wherein the second token remains valid longer than the first token;
associating, by the one or more computing devices, the second token with a user account identifier;
generating, by the one or more computing devices, a code for use in an offline exchange between the user computing device and a merchant computing device;
associating, by the one or more computing devices, the code with the user account identifier;
communicating, by the one or more computing devices, the code and the user account identifier to the user computing device;
receiving, by the one or more computing devices and from the merchant computing device, the code and the user account identifier after the user computing device communicated the code and the user account identifier to the merchant computing device while the user computing device was in an offline state with respect to the one or more computing devices, wherein the merchant computing device is distinct from both the one or more computing devices and the user computing device;
identifying, by the one or more computing devices and based on the user account identifier received from the one or more merchant computing devices, the second token associated with the user account identifier;
verifying, by the one or more computing devices, that the code received from the merchant computing device matches the code associated with the user account identifier; and
in response to verifying that the code received from the merchant computing device matches the code associated with the user account identifier, authenticating the communication between the user computing device and the merchant computing device while the user computing device was in an offline state with respect to the one or more computing devices.

2. The computer-implemented method of claim 1, wherein authenticating the communication comprises authorizing, by the one or more computing devices and using the second token, a sales transaction involving the user account.

3. The computer-implemented method of claim 1, wherein receiving the code and the user account identifier from the one or more merchant computing devices comprises:
receiving, by the one or more merchant computing devices, the code and the user account identifier from the user computing device;
communicating, by the one or more merchant computing devices, the code and the user account identifier to the one or more computing systems.

4. The computer-implemented method of claim 3, wherein receiving the code and the user account identifier from the user computing device comprises scanning a bar code or a Quick Response Code comprising the code, the user account identifier, or both the code and the user account identifier.

5. The computer-implemented method of claim 1, wherein the code comprises a shared random counter.

6. The computer-implemented method of claim 1, wherein the second token remains valid for two weeks.

7. The computer-implemented method of claim 1, wherein the user computing device periodically communicates a first token to the one or more computing systems.

8. The computer-implemented method of claim 7, wherein the user computing device communicates the first token to the one or more computing devices every three days.

9. The computer-implemented method of claim 1, wherein verification of the rescue code further comprises recalculating a shared secret rescue code computation.

10. A computer program product, comprising:
a non-transitory computer-readable medium having computer-executable program instructions embodied therein that when executed by a computer cause the computer to complete offline transactions, the computer-executable program instructions comprising:
computer-executable program instructions to receive a first token from a user computing device, wherein the user computing device is associated with a user financial account of a user;
computer-executable program instructions to generate, in response to receiving the first token, a second token, wherein the second token remains valid longer than the first token;
computer-executable program instructions to associate the second token with a user account identifier;
computer-executable program instructions to generate a code for use in an offline sales transaction of the user, wherein the code is associated with the user account identifier;
computer-executable program instructions to communicate the code and the user account identifier to the user computing device;
computer-executable program instructions to receive, from one or more merchant computing devices, the code and the user account identifier after the user computing device communicated the code and the user account identifier to the merchant computing device while the user computing device was in an offline state with respect to the one or more computing devices, wherein the merchant computing device is distinct from the user computing device;
computer-executable program instructions to identify, based on the user account identifier received from the one or more merchant computing devices, the second token associated with the user account identifier;
computer-executable program instructions to verify that the code received from the merchant computing device matches the code associated with the user account identifier; and
computer-executable program instructions to authenticate, in response to verifying that the code received from the merchant computing system matches the code associated with the user account identifier and using the second token, the communication between the user computing device and the merchant computing device while the user computing device was in an offline state with respect to the one or more computing devices.

11. The computer program product of claim 10, wherein receiving the code and the user account identifier from the one or more merchant computing devices comprises:
receiving, by the one or more merchant computing devices, the code and the user account identifier from the user computing device, wherein receiving the code and the user account identifier from the user computing device comprises scanning a bar code or Quick Response Code comprising the code, the user account identifier, or both the code and the user account identifier; and
communicating, by the one or more merchant computing devices, the code and the user account identifier to the one or more computing systems.

12. The computer program product of claim 10, wherein the code comprises a shared random counter.

13. The computer program product of claim 10, wherein the second token remains valid for about two weeks, about three weeks, or about four weeks.

14. The computer program product of claim 10, wherein verification of the code further comprises recalculating the code.

15. A system to complete offline transactions, comprising:
a storage device; and
a processor communicatively coupled to the storage device, wherein the processor executes application code instructions that are stored in the storage device to cause the system to:
receive a first token from a user computing device, wherein the user computing device is associated with a user financial account of a user;
generate, in response to receiving the first token, a second token, wherein the second token remains valid longer than the first token;
associate the second token with a user account identifier;
generate a key code for use in an offline sales transaction of the user, wherein the key code is associated with the user account identifier;
communicate the key code and the user account identifier to the user computing device;
receive, from one or more merchant computing devices, the key code and the user account identifier after the user computing device communicated the key code and the user account identifier to the merchant computing device while the user computing device was in an offline state with respect to the one or more computing devices, wherein the merchant computing device is separate from the user computing device;
identify, based on the user account identifier received from the one or more merchant computing devices, the second token associated with the user account identifier;
verify that the key code received from the merchant computing system matches the code associated with the user account identifier; and
in response to verifying that key code received from the merchant computing system matches the key code associated with the user account identifier and using the second token, authenticate the transaction while the user computing device was in an offline state with respect to the one or more computing devices.

16. The system of claim 15, wherein receiving the key code and the user account identifier from the one or more merchant computing devices comprises:
receiving, by the one or more merchant computing devices, the key code and the user account identifier from the user computing device; and
communicating, by the one or more merchant computing devices, the key code and the user account identifier to the processor.

17. The system of claim 16, wherein receiving the key code and the user account identifier from the user computing device comprises scanning a bar code or Quick Response Code comprising the key code, the user account identifier, or both the key code and the user account identifier.

18. The system of claim 15, wherein the key code comprises a shared random counter.
